(19) United States
(12) Patent Application Publication
(10) Pub. No.: US 2013/0345035 A1
(43) Pub. Date: Dec. 26, 2013

(54) PAPER MACHINE ROLLER WITH FIBER BRAGG SENSORS

(71) Applicant: Voith Patent GmbH, Heidenheim (DE)

(72) Inventors: Antje Berendes, Bergatreute (DE); Martin Breineder, Natschbach (AT); Matthias Schmitt, Munchen (DE); Yang Shieh, Wallingford, PA (US)

(73) Assignee: Voith Patent GmbH, Heidenheim (DE)

(21) Appl. No.: 13/974,632

(22) Filed: Aug. 23, 2013

Related U.S. Application Data
(63) Continuation of application No. PCT/EP2012/052845, filed on Feb. 20, 2012.

(30) Foreign Application Priority Data
Feb. 25, 2011 (DE) 102011004777.8
Feb. 15, 2012 (DE) 102012202245.7

(51) Int. Cl. F16C 13/00

(52) U.S. Cl. CPC F16C 13/00
USPC 492/48

(57) ABSTRACT

A roller for use in paper machines includes a roller core, a roller covering surrounding the roller core, and at least one optical waveguide having a plurality of fiber Bragg gratings. The at least one optical waveguide is either arranged between the roller core and the roller covering or is embedded in the roller covering. Sections of the at least one optical waveguide which each contain a fiber Bragg grating alternate with sections of the at least one optical waveguide which are free of fiber Bragg gratings in the longitudinal direction of the optical waveguide. Sections of the at least one optical waveguide which each contain a fiber Bragg grating also enclose an angle with a circumferential direction to the roller of less than 80°, for example less than 60°, or less than 45°.

### CROSS REFERENCE TO RELATED APPLICATIONS

This is a continuation of PCT application No. PCT/EP2012/052845, entitled “PAPER MACHINE ROLLER HAVING FIBRE BRAGG SENSORS”, filed Feb. 20, 2012, which is incorporated herein by reference.

### BACKGROUND OF THE INVENTION

1. Field of the Invention

The present invention relates to rollers for use in machines for industrial paper production, which are equipped with fiber Bragg sensors to detect pressure being exerted on the roll.

2. Description of the Related Art

To form a fibrous web in industrial paper manufacturing, a suspension is first placed on a carrier, for example a fabric, and is dewatered. Dewatering is continued subsequent to formation in consecutive sections of the paper machine, until finally a self-supporting fibrous web is produced. During the dewatering process the not yet self-supporting fibrous web is usually transferred to other carriers, for example felts or other fabrics. In the forming section as well as in the wet section, the fibrous web together with the respective supporting carrier is routed through a series of nips. The term “nip” refers to the region between two interacting rolls, or respectively between one roll and so-called shoes pressing against it, in which area the fibrous web is pressed or respectively put under pressure. The pressure profile being created by the fibrous web passing through the nips has a substantial influence on the efficiency with which the fibrous web is dewatered and smoothed. In the event of uneven pressure distribution in the nip, the fibrous web will have an uneven moisture profile, or respectively poor smoothing. Paper manufacturers are therefore anxious to monitor the pressure profiles in the nip regions.

The utilized rollers usually have a roll core which absorbs the load. Depending on the particular stage in the production process in which the fibrous web is being processed, the surfaces of the rolls making contact with the fibrous web must have different characteristics. The rolls are therefore usually equipped with a roll cover in the region of their circumferential surface which comes into contact with the fibrous web, the cover having the desired characteristics. The roll cover may be a multi-layer cover. The layer immediately adjoining the roll core and providing the interface between the roll core and the roll cover is often referred to as the “base layer”.

To monitor the pressure profile in the nip during operation, sensors can be used. The sensors are normally arranged on the outer circumferential surface of the roll core, or embedded in the roll cover. Forces acting radially relative to the roll geometry are usually acquired with the use of piezoelectric or electro-mechanic sensors. Both types of sensors produce an electric signal which is representative of their deformation under particular pressure conditions. Since the rotational speed of the rolls in modern paper machines is very high, the sensor signal values are preferably transmitted wirelessly to external processing devices.

Instead of sensors operating with electric means, fiber optic sensors may be used in which the optical properties of an optical waveguide (for example a glass fiber) are changed by the deformation stresses transmitted to the optical waveguide. In international patent application PCT/EP2008/08050 fiber-optic sensors for use in roll covers for paper machines are described, which use fiber Bragg gratings written into glass fibers as the sensor elements. Fiber Bragg gratings are optical interference filters arranged in optical wave guides, which are written, for example, by means of a laser into the optical waveguide. Wavelengths, which are within the predetermined filter bandwidth of around X_{B} are reflected. The disclosure of WO 2010/034321 A1 with respect to the operation of fiber Bragg gratings is incorporated herein in its entirety.

What is needed in the art is a roll for use in paper machines, which permits the determination of a pressure acting on the roll and its progression relative to the roll geometry (for example, a nip) in a reliable manner and which, nevertheless can also be produced economically. Moreover a process for the production of such a roller is also needed.

### SUMMARY OF THE INVENTION

The present invention provides a roll for use in paper machines which has a roll core, a roll cover which surrounds the roll core and at least one optical waveguide having a plurality of fiber Bragg gratings. The roll core may be made, for example, of metal (for example steel) or plastic (for example carbon fiber reinforced plastic CFRP or a fiber-plastic composite FPC) and can be solid or hollow. Moreover, the roll core may optionally be a single or a multi-component roll core. The roll cover can, for example, be formed from plastic. The at least one optical waveguide may be either disposed between the roll core and the roll cover, or can be embedded in the roll cover. If the at least one optical waveguide is embedded in the roll cover, it may optionally be embedded in one layer of the roll cover or may be disposed between two layers of the roll cover. In this document, the layer which is often referred to as the “base layer” and which adjoins directly on the roll core and establishes the connection between the roll core and the roll cover, is understood to be a layer of the roll cover, even if it is formed of the same material as the roll core. Segments of the at least one optical waveguide which contain a fiber Bragg grating (hereinafter referred to as fiber Bragg grating segments) alternate in the longitudinal direction of the optical waveguide with segments of the at least one optical waveguide which do not contain a fiber Bragg grating (hereinafter, fiber Bragg grating-free segments). Fiber Bragg grating segments enclose an angle with a circumferential direction to the roller of less than approximately 80°, for example less than 60°, or less than 45°.

In one embodiment of the present invention, the at least one optical waveguide is frictionally connected in the fiber Bragg grating sections to the adjacent roll core and/or roll cover. The fiber Bragg grating segments and the adjacent roll core and/or roll cover directly adjoin and contact each other. In such an orientation of fiber Bragg grating segments of the optical waveguide, a radial compressive load on the roll leads to a tensile load of the optical waveguide in this segment. A temporary and reversible displacement of the roll cover in the circumferential direction caused by the compressive load is viewed as the reason. Subject to this tensile load, the wave length range of the radiation reflected by the fiber Bragg grating shifts. The reason is a shift of the distance between refractive index transitions in the optical waveguide. This shift in the wavelength range thus allows conclusions to be reached regarding the pressure load on the roller.

It is hereby not detrimental if individual fiber Bragg grating segments enclose an angle with a circumferential direction to the roll of greater than 80° as long as more than 50% of the segments, for example more than 70% of the segments, or more than 90% of the segments enclose an angle of less than 80°, for example less than 60°, or less than 45°. Fiber Bragg grating portions which enclose an angle with a circumferential direction to the roll of greater than 80°, enclose an angle less than 10° with the axial direction of the roller and thereby progress approximately parallel to the axial direction. In the event of a compressive load on the roll, fiber Bragg grating segments oriented thusly are subjected to only a small tensile load (or, in the case of an axial orientation, to none) so that a determination of the pressure is difficult or impossible. Fiber Bragg grating-free segments located between the fiber Bragg grating segments extend as desired. Overall, the optical waveguide may be arranged wavelike or meandering.

According to an additional embodiment of the present invention, a roll for use in paper machines includes a roll core and a roll cover surrounding the roll core and at least one optical waveguide with a plurality of fiber Brag gratings, whereby the at least one optical wavelength guide progresses along a longitudinal extension between the roll core and the roll cover, or embedded into the roll cover, on a cylinder surface concentric to the rotational axis of the roll. In other words, the optical waveguide extends on a cylinder surface concentric to an axis of rotation of the roller, which is formed either by the interface between the roll core and the roll cover, or is disposed within the roll cover. Moreover, fiber Bragg grating segments of the at least one optical waveguide alternate with fiber Bragg grating-free segments of the at least one optical waveguide in the longitudinal direction of the optical waveguide. In the roll according to this embodiment of the present invention, it is moreover provided that at least some of the fiber Bragg grating-free segments which are arranged between the roll core and the roll cover, or which are embedded in the roll cover progress curved on the cylinder surface.

Through the curved progression of the fiber Bragg grating-free segments in a single radial height, the fiber Bragg grating segments can be oriented virtually at random. In particular it is hereby possible to orient the fiber Bragg grating segments so that they form an angle with the circumferential direction of the roll of less than 80°, for example less than 60°, or less than 45°.

Moreover, due to the curved progression of the fiber Bragg grating-free segments, the distances between the fiber Bragg gratings to each other can be varied within a large range, thereby being able to vary the distance of the fiber Bragg gratings in the roll and thereby the distance of the sensors to each other and thereby being able to adjust the spatial resolution according to the requirements of the roll, for example in the axial direction of the roll.

It is also conceivable that different fiber Bragg grating-free segments of the at least one optical waveguide have a different length, varying by a maximum of 30%, for example by a maximum of 10%. It is further feasible for the plurality of fiber Bragg grating-free segments of the at least one optical waveguide to be of the same length. This allows the fiber optical waveguide to be manufactured for almost any roll, regardless of the length and circumference of the roll; and the spacing between fiber Bragg gratings in the roll cover can be set by the curved progression of the fiber Bragg grating-free segments.

To avoid excessive damping of the light in the curved progression of the at least one optical waveguide, it is useful if the optical waveguide does not progress at too great a curvature. This is particularly useful, as in the confined space of a roll, for example, for a paper, board or tissue machine, only relatively faint light sources can be used, which do not generate significant heat and therefore do not require costly and space consuming cooling equipment. A further embodiment of the present invention provides that the at least one optical waveguide progresses at least segmentally curved in its longitudinal extension which is arranged between the roll core and the roll cover or embedded in the roll cover and that the radius of curvature of the curved progression of the optical waveguide is approximately 2 centimeters (cm) or greater, for example 3 cm or greater, or 5 cm or greater.

At least some, for example all, fiber Bragg grating-free segments of the at least one optical waveguide arranged, for example between the roll core and the roll cover, or embedded in the roll cover respectively, are curved in only one direction. For example, in the case of two fiber Bragg grating-free segments between which one fiber Bragg grating segment is arranged this can mean that one of the two fiber Bragg grating-free segments has a positive curvature and the other of the two fiber Bragg grating-free segments has a negative curvature or vice versa.

Therefore, successive fiber Bragg grating-free segments of at least one optical waveguide, between which one fiber Bragg grating segment of the at least one optical waveguide is arranged, may be curved in different directions relative to each other.

The at least one optical waveguide may have a core and a casing surrounding the core or can be formed therefrom, at least along the length along which it is embedded in the roll cover, or between the roll core and the roll cover. For example, the casing is hereby in contact either directly with the roll core and the roll cover, or directly with the roll cover in the region of the fiber Bragg grating segments. According to this embodiment, therefore, the fiber Bragg grating segments of the optical waveguide, in contrast to what is disclosed in WO 2010/034321 Al, are applied directly to the roll cover through dynamic effect without an intermediate element—designated here as “stud element” . Surprisingly, trials by the applicant have shown that to obtain a sufficient signal sensitivity, the use of the intermediate elements described in WO 2010/034321 A1 are not essential.

Fiber Bragg grating segments arranged between the roll core and the roll cover, or in the roll cover, are subject to a maximum tensile load in the event of a compressive load on the roller, if the segments enclose an angle of 0° with the circumferential direction to the roll. In this case, the fiber Bragg grating segments exhibit the greatest signal sensitivity. Generally it should be noted that the signal sensitivity becomes greater with a decreasing angle that the fiber Bragg grating segments of the optical waveguide enclose with the circumferential direction of the roll and, as already explained above, is zero in a parallel orientation to the axial direction of the roller.

To achieve a high signal sensitivity, an embodiment of the present invention provides that the fiber Bragg grating segments enclose an angle with a circumferential direction to the roller of less than 30°, for example less than 20°, or less than 10°.

Depending on the arrangement of the optical waveguide on the roll core or in the roll cover, on the materials used for the roll core and the roll cover, on the diameter of the roll and on the pressures which occur, there is a risk for example with soft roll covers, that the tensile load on the optical waveguide becomes too great, thus resulting in irreversible damage to the optical waveguide. For some applications it may therefore be useful if the fiber Bragg grating segments enclose an angle of greater than 10°, for example greater than 20°, or greater than 30° with a circumferential direction to the roller. With such an incline a sufficient tensile load of the optical waveguide occurs on the one hand in the case of a compressive load on the roll, and at the same time prevents irreversible damage of the optical waveguide due to excessive tensile load.

According to one embodiment of the present invention, fiber Bragg grating segments are arranged adjacent to each other in the axial direction of the roll. In this case fiber Bragg grating segments can be disposed in a region extending over the entire roll length in the axial direction, whereby the extension in the circumferential direction is less than 15 cm, for example less than 5 cm, or less than 1 cm. This allows a determination of the pressure gradient in the axial direction of the roll at a certain angle of rotation of the roller.

According to one embodiment, fiber Bragg grating segments are spaced apart at a constant distance in the axial direction of the roller. This allows a uniform determination of the pressure gradient in the axial direction of the roll. This constant distance can be measured, for example, from the center of the respective fiber Bragg grating.

According to an alternative embodiment, fiber Bragg grating segments are arranged in the axial direction of the roll in a first region at a first distance from each other and in at least a second region are arranged at a second distance from each other, whereby the second distance is, for example at least 30%, at least 60%, or at least 90% greater than the first distance. This constant distance can be measured, for example from the center of the respective fiber Bragg grating. Such an arrangement allows a determination of the pressure gradient in the axial direction of the roller, wherein the density of the fiber Bragg gratings, and thus the obtained measured pressure values in the regions of concern in the axial direction of the roll (for example in the vicinity of the roller bearing) is greater than in other regions in the axial direction of the roll (for example in the center of the roll). If several second regions are provided, then the second distances in the second regions may be equal (and particularly equal in pairs), or different. A continuous change of the distances is also possible.

According to one embodiment of the present invention, the roller has more than one optical waveguide, and adjacent fiber Bragg grating segments of different optical waveguides are arranged in a region extending in a circumferential direction over the entire roll circumference and thereby generally over an annular region whose extension in the axial direction of the roll is less than approximately 10 cm, for example less than 3 cm, or less than 1 cm. The above condition must not be met by all of the adjacent segments of different optical waveguides. Rather, it is sufficient if this condition is met by pairs of individual fiber Bragg grating segments of different optical waveguides. Thereby, the (immediately) adjacent fiber Bragg gratings of different optical waveguides are arranged along the strips, which circumferentially surround the roller in this embodiment. This allows a determination of the compression load at different angles of rotation of the roller.

For example, in this connection adjacent fiber Bragg grating segments of different optical waveguides, which are arranged in the region whose extension in the axial direction of the roll is less than 10 cm, for example less than 3 cm or less than 1 cm, are arranged in the circumferential direction of the roller, offset relative to each other by 45° or more, for example 90° or more.

According to an alternative embodiment of the present invention, fiber Bragg grating segments are arranged adjacent to each other in the circumferential direction of the roll. In this case, fiber Bragg grating segments can be disposed in a region extending in the circumferential direction over the entire roll circumference, whereby the extension of the region in the axial direction of the roll is less than approximately 15 cm, for example less than 5 cm, or less than 1 cm. This allows a determination of the pressure load of the roll at different angles of rotation of the roller.

According to one embodiment, the roll is equipped with more than one optical waveguide and adjacent fiber Bragg grating segments of different optical waveguides are arranged in a region extending in an axial direction over the entire length of the roll, whereby the extension of the region in the circumferential direction of the roll is less than 15 cm, for example less than 5 cm, or less than 1 cm. This allows a determination of the pressure load in the axial direction of the roll at different angles of rotation of the roller.

According to one embodiment, fiber Bragg gratings of the same optical waveguide which are arranged at distances from each other in the longitudinal direction of the optical waveguide are configured to reflect light of different wavelengths. This allows assignment of a measurement signal to the respective fiber Bragg grating of the same optical waveguide, if the fiber Bragg gratings of the same optical waveguide are at the same time subject to tension load. Thus, a spatial resolution is also possible, if the fiber Bragg gratings of the same optical waveguide are arranged in a narrow region in the axial direction of the roll, which is subjected at the same time to a compressive load.

According to one embodiment of the present invention, fiber Bragg gratings of the same optical waveguide arranged at distances from each other in the longitudinal direction of the optical waveguide are configured to reflect light of the same wavelength. Such optical waveguides are particularly easy to manufacture. However, spatial resolution is then only possible if the fiber Bragg gratings of the same optical waveguide are arranged in the circumferential direction of the roll, offset from one another, and hence are subjected to a compressive load at different times.

According to another embodiment of the present invention, fiber Bragg grating segments are disposed along a helical curve along the surface of the roller, wherein a deviation from the helical curve in the axial direction of the roll as well as in the circumferential direction of the roll is less than 15 cm, for example less than 5 cm, or less than 1 cm. This allows a pressure measurement in different axial regions of the roller at various angles of rotation of the roller.

According to an additional embodiment of the present invention, one end of the at least one optical waveguide is directed out of the roll cover. According to a further embodiment, both ends of the at least one optical waveguide are directed out of the roll cover. According to an alternative embodiment, a light source and a light detector are disposed in the roll, which are connected with the at least one optical waveguide and configured to conduct measurements relative to the fiber Bragg gratings of the at least one optical waveguide. The light detector may be connected to a transmitter to emit measurement data obtained over an air interface to the outside of the roll. Moreover, a coil can be arranged in the roll in which a current flow can be excited through induction from the outside in order to supply the components included in the roll with energy.

According to one embodiment, the roll cover includes several layers and the at least one optical waveguide is arranged between two layers of the roll cover. According to an alternative embodiment, the roll cover consists of several layers, and the at least one optical waveguide is embedded in one of the several layers and is surrounded by the latter. This allows for easy and secure attachment of at least one optical waveguide. Moreover, the optical waveguide is thus well protected against damage.

According to another embodiment of the present invention, the at least one optical waveguide is embedded in epoxy resin. Epoxy resin permits good transfer of the compressive forces acting on the roller to the at least one optical waveguide.

The present invention also provides a method for the production of a roll for use in paper machines including the following steps:
providing a roll core with or without a roll cover layer;
providing at least one optical waveguide with a plurality of fiber Bragg gratings, wherein fiber Bragg grating segments alternate with fiber Bragg grating-free segments in a longitudinal direction of the optical waveguide;
attaching the fiber Bragg grating segments on the roll core, or respectively the roll cover layer, so that the segments enclose an angle with a circumferential direction to the roll of less than 45°, for example less than 20°, or less than 10°; and
applying at least one additional roll cover layer, which covers the at least one optical waveguide.

It is thus sufficient to first attach the fiber Bragg grating segments so that fiber Bragg grating-free segments can be guided initially as desired. However, the minimum permitted bending radii of the utilized optical waveguides should be considered. The optical waveguides can herewith be quickly, easily and inexpensively integrated into the rollers. Attachment of the fiber Bragg grating segments to the roll core, or respectively the roll cover layer, may be permanent, for example with epoxy resin, or detachable, for example with adhesive tape.

According to an additional embodiment of the present invention a method for the production of a roll for use in paper machines is provided including the following steps:
providing a roll core having an axis of rotation, with or without a roll cover layer, wherein the roll core or the roll cover layer provides a cylindrical surface concentric to the axis of rotation;
providing at least one optical waveguide with a plurality fiber Bragg gratings, whereby fiber Bragg grating segments alternate with fiber Bragg grating-free segments in the longitudinal direction of the optical waveguide;
attaching the optical waveguide to the cylinder surface so that the fiber Bragg grating-free segments progress at least in sections curved on the cylindrical surface; and
applying at least one additional roll cover layer which covers the at least one optical waveguide.

According to another embodiment of the method according to the present invention, one step of placing a marking on the roll core or the roll cover layer occurs prior to the step of attaching the fiber Bragg grating segments, whereby the marking identifies the points or regions at which a pressure measurement is to occur. This marking can, for example, also be in the form of a groove into which the optical waveguide is to be inserted. The accuracy of the arrangement of the fiber Bragg grating segments can hereby be increased.

According to an additional embodiment of the method of the present invention, a step of attaching the fiber Bragg grating-free segments to the roll core or the roll cover layer occurs before the step of applying the at least one cover layer. This ensures that the one optical waveguide fits closely over its entire surface against the roll core or the roll cover layer. If a releasable attachment for attaching of the fiber Bragg grating segments on the roll core or the roll cover layer is used, a release of the releasable attachment and replacement through a permanent attachment can be provided.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic perspective view of a roller according to a first embodiment of the present invention in which a section of the cover is removed and the optical waveguide with fiber Bragg gratings is exposed;

FIG. 1a is an enlargement of a schematic sectional view of the roll cover illustrated in FIG. 1;

FIG. 2 is a schematic perspective view of a roller according to a second embodiment of the present invention in which a section of the cover is removed and the optical waveguide with fiber Bragg gratings is exposed;

FIG. 3 is a schematic perspective view of a roller according to a third embodiment of the present invention in which a section of the cover is removed and the optical waveguide with fiber Bragg gratings is exposed;

FIG. 4 is a schematic perspective view of a roller according to a fourth embodiment of the present invention in which a section of the cover is removed and the optical waveguide with fiber Bragg gratings is exposed; and

FIG. 5 is a schematic perspective view of a roller according to a fifth embodiment of the present invention in which a section of the cover is removed and the optical waveguide with fiber Bragg gratings is exposed.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

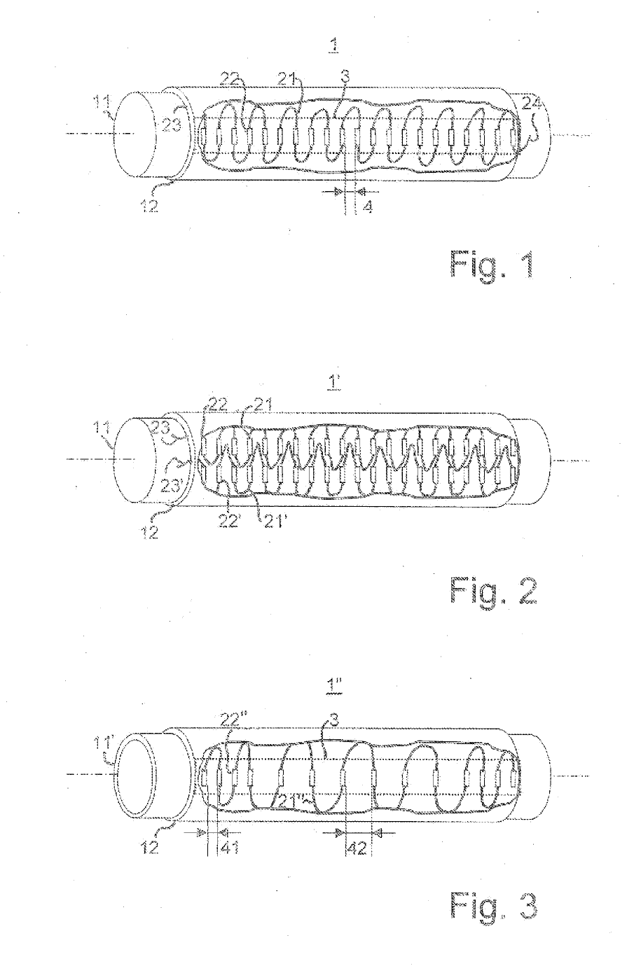

Referring now to FIG. 1, there is shown a perspective view of a roller 1 according to a first embodiment of the present invention. Roller 1 includes a roll core 11 providing a rotational axis 44, as well as a roll cover 12 surrounding roll core 11. In this embodiment, roll core 11 is formed from, for example, steel and roll cover 12 from plastic. To provide good adhesion between roll cover 12 and roll core 11, an intermediate layer which is a known to the expert as a “base layer” is provided between roll cover 12 and roll core 11, which is not specifically shown in the figure.

A partial section of roll cover 12 is exposed in FIG. 1 and provides a view of an optical waveguide 21 with a plurality of fiber Bragg gratings 22. Individual fiber Bragg gratings 22 of optical waveguide 21 are configured to reflect light of different wavelengths.

As can be seen from the illustration in FIGS. 1 and 1a, optical waveguide 21 has fiber Bragg grating segments 22, as well as fiber Bragg grating-free segments 43′, 43″, wherein fiber Bragg gratings segments 22 and fiber Bragg grating-free segments 43′, 43″ alternate in the longitudinal direction of optical waveguide 21.

Optical waveguide 21 is arranged in a meandering pattern in roll cover 11 and extends in the axial direction of the roll over the entire width of roll cover 12. Segments of optical waveguide 21, each of which contain a fiber Bragg grating 22 (hereinafter referred to as fiber Bragg grating segments 22), are arranged so that these segments respectively, together with a circumferential direction to roll 1, enclose an angle of approximately 0°. “Approximately 0°” means hereby that deviations from 0° of up to 15°, for example not more than 10°, can be tolerated.

In this first embodiment, adjacent fiber Bragg grating segments 22 which are located along one extension of optical wave guide 21 are arranged adjacent in the axial direction of roll 1, in a region 3, whose extension in the circumferential direction of roll core 11 is precisely 1 cm. Thus, fiber Bragg grating segments 22 which are arranged adjacent in the axial direction may have an offset in the circumferential direction of not more than 1 cm. The distance between fiber Bragg grating segments 22 arranged adjacent in the axial direction of the roll is selected to be constant.

Due to this arrangement of fiber Bragg grating segments 22, a compressive load on roll cover 12 results in an (insignificant) expansion of optical waveguides 21 with the fiber Bragg gratings and thereby to a change in the wavelength of the light reflected by the individual fiber Bragg gratings. In this way it is possible to measure a compressive load on the roll along a line extending in the axial direction of roll 1. In the illustrated embodiment, both ends 23 and 24 of the optical waveguide are directed to the outside to be connected to a measuring device which is not shown in FIG. 1.

Referring now to FIG. 1a, there is shown an enlarged schematic sectional view of roll cover 12 of the illustration in FIG. 1. In the radial direction of roll 1, roll cover 12 has an inner cylindrical surface 12i, as well as in the radial direction of roller 1 an outer surface 12a, whereby the latter provides the surface of the roll cover which will be brought into contact with a material web or clothing. Both cylindrical surfaces 12i and 12a are herein arranged concentrically relative to the rotational axis 44.

Inside roll cover 12 is a cylindrical surface 12k which is positioned concentrically to axis of rotation 44, and on which is arranged at least one optical waveguide 21 and on which fiber Bragg grating-free segments 43′, 43″ of optical waveguide 21 extend in a curve. Concentric cylindrical surface 12k, may for example be formed by the radially outer surface of radially inner roll cover layer 12′ on which optical waveguide 21 is arranged and which in turn is covered by radially outer roll cover layer 12″ with the result that the at least one optical waveguide 21 is embedded in roll cover 12.

It must be mentioned that the radius of curvature of the curved progression of optical waveguide 21 is approximately 2 cm or greater.

Moreover, one recognizes that each fiber Bragg grating-free segment 43′, 43″ is curved in only one single direction of curvature, and that successive fiber Bragg grating-free segments 43′, 43″ between which fiber Bragg grating segment 22 is arranged, are curved in different directions of curvature relative to each other. Thus, for example, segment 43′ is curved in opposite direction to curved segment 43″. Moreover, all fiber Bragg grating-free portions 43 embedded in roll cover 12 have the same length.

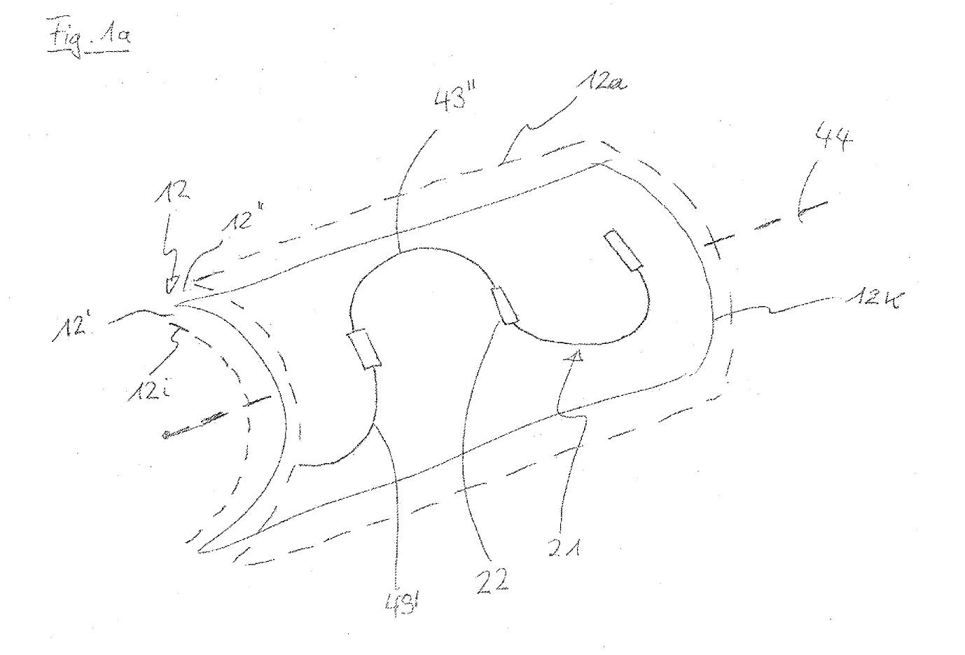

Referring now to FIG. 2, there is shown a second embodiment of roll 1′ in a schematic perspective view. Since this embodiment is very similar to the previously described embodiment, only the differences are addressed and we otherwise refer to the first embodiment.

The second embodiment shown in FIG. 2 differs from the previously described first embodiment particularly in that a second optical waveguide 21′ with fiber Bragg grating segments 22′ is provided which is offset in the circumferential direction relative to first optical waveguide 21 with the fiber Bragg grating segments 22. This second optical waveguide 21′ is accessible from the outside via a connection 23′. In this second embodiment, the two ends of optical waveguides 21, 21′ are not directed to the outside.

Fiber Bragg grating segments 22′ of second optical wave guide 21′ are arranged offset in the circumferential direction of the roll, located under fiber Bragg grating segments 22 of first optical waveguide 21 so that fiber Bragg grating segments 22, 22′ which are arranged adjacent in the circumferential direction of the roll circumference are offset in the axial direction of roll 1′ by less than 3 cm. Thus circumferentially adjacent fiber Bragg grating portions 22, 22′ are disposed on a narrow ring surrounding the roll in the circumferential direction. In the axial direction, fiber Bragg grating segments 22, 22′ of each optical waveguide 21, 21′ are arranged as described in the first embodiment.

Such an arrangement of optical waveguides 21, 21′ and fiber Bragg grating segments 22, 22′ allows measurement of a pressure distribution in the axial direction of the roll at different angles of rotation of the roll.

Referring now to FIG. 3, there is shown a schematically illustrated perspective view of a roll 1″ according to a third embodiment of the present invention. Since this embodiment is very similar to the previously described first and second embodiments, only the differences are addressed and we otherwise refer to the first and second embodiments. The third embodiment shown in FIG. 3 differs from the previously described first and second embodiments on the one hand in that instead of a solid roll core 11, a roll core 11 in the embodiment of a carbon fiber reinforced plastic (CFRP) tube is used. Arranged inside the tube, is a measuring device including a light source and a light detector for emitting light into optical waveguide 21″ and detecting the light reflected by the fiber Bragg gratings of optical waveguide 21″, a microprocessor for obtaining a measured result based on the values output from the light detector, and a transmitter for output of a test result via an air interface to the outside. The required energy is fed inductively to the measuring device upon rotation of roller 1″.

The third embodiment moreover distinguishes itself from the first embodiment in the arrangement of fiber Bragg grating segments 22″. In the third embodiment, fiber Bragg grating segments 22″ are located in the axial direction of roll 1″ in pairs either at a first distance 41 or a second distance 42 from each other. In the illustrated embodiment, the second distance 42 is twice the first distance 41. The arrangement of fiber Bragg grating segments 22′ in this embodiment is such that the density of the fiber Bragg grating segments at the ends of roll 1″ and therefore in the region of the bearings is greater than in the center of roll 1″. This allows measurement of compression forces upon the roll in particular in regions of concern. On the rear side of roll 1″ shown in FIG. 3, a second optical waveguide with fiber Bragg gratings is provided which, with respect to first optical waveguide 21 and its fiber Bragg grating segments 22″ is arranged as described in the second embodiment.

A fourth embodiment of a roller 1″ is shown in a schematically perspective view in FIG. 4. Since this embodiment is very similar to the previously described first to third embodiments, only the differences are addressed and we otherwise refer you to the preceding embodiments.

In the fourth embodiment of the present invention, optical waveguides 21, 21′ with fiber Bragg grating segments 22, 22′ arranged so that the individual optical waveguides 21, 21′ are arranged between two layers of roll cover 12 (the individual layers are not specifically shown), and respectively surround roll 1″ ring-shaped in the circumferential direction. Thus, along an extension of optical waveguide 21, adjacent fiber Bragg grating segments 22 of the same optical waveguide 21 are arranged adjacent in the circumferential direction of the roll, wherein a distance 5 between two adjacent fiber-Bragg grating segments 22′, 22 is selected to be constant. In relation to the axial direction of roll 1″', fiber Bragg grating segments 22, 22′ of always the same optical waveguide 21, 21′ are arranged in a region 6 extending in the circumferential direction over the entire roll circumference whereby the extension of region 6 in the axial direction of the roll is 1.5 cm.

Fiber Bragg grating segments 22, 22′ of different optical waveguides 21, 21′ which are arranged adjacent to each other in the axial direction are arranged in the current embodiment of the present invention adjacently to each other at a constant distance from each other and are disposed so that their arrangement is offset in the circumferential direction of the roll by less than 1 cm.

In this fourth embodiment, the fiber Bragg gratings of the same optical waveguide 21, 21′ are each configured to reflect light of the same wavelength. With knowledge of the angular position of roll 1″″ such an arrangement of optical waveguides 21, 21′ and fiber Bragg gratings permits detection of the pressure distribution in the axial direction of roll 1″ at different angles of rotation of the roller. As in the third embodiment, roll core 11′ in the fourth embodiment is hollow and accommodates a measuring device which is connected with optical waveguides 21, 21′.

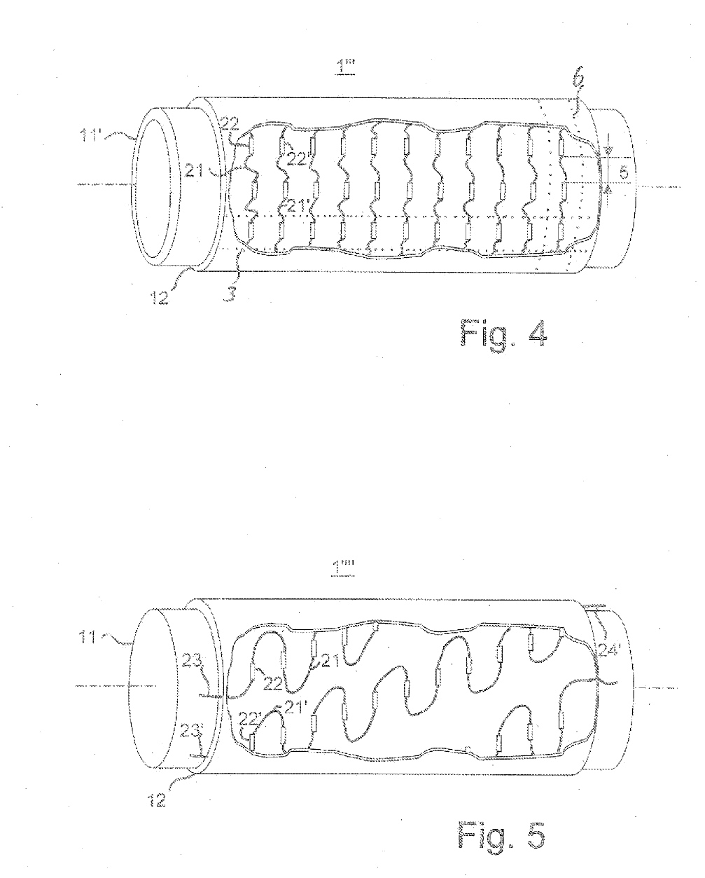

Referring now to FIG. 5, there is shown a schematic illustration of a perspective view of roll 1″ according to a fifth embodiment. In this embodiment too, a section of roller cover 12 surrounding solid roller core 11 consisting of fiber-plastic composite FPC is exposed, providing a view of a plurality of optical waveguides 21, 21′ with fiber Bragg grating segments 22, 22′ embedded in a “base layer” of epoxy resin. In this embodiment, both ends 23, 23′, 24′ of optical waveguides 21, 21′ are directed to the outside. Fiber Bragg grating segments 22, 22′ of individual optical waveguides 21, 21′ are arranged respectively according to this embodiment along a helical curve, which covers the roll completely in the axial direction and partially in the circumferential direction. In this case too, the arrangement of the fiber Bragg gratings of adjacent optical waveguides 21, 21′ is such that fiber Bragg gratings arranged adjacent in the circumferential direction have no offset, or only a small offset in the axial direction of the roll.

Even though in FIGS. 1 through 5, the fiber Bragg grating portions together with the circumferential direction of the roll enclose an angle of approximately 0°, the current invention is not limited thereto. Rather, it is sufficient if the angle is less than 80°, for example less than 60° or less than 40°. Provision of a certain angle of, for example greater than 10°, for example greater than 20°, or greater than 30° may even be required at very high pressures and/or embedding the at least one optical waveguide into a relatively soft roll cover in order to avoid excessive tensile load on the at least one optical waveguide.

For example, the fiber Bragg grating segments, together with the circumferential direction of the roll, may enclose the following angular ranges α:

10<α<80; 20<α<80; 30<α<80;

10<α<60; 20<α<60; 30<α<60;

10<α<40; 20<α<40; and 30<α<40.

Below, a method is briefly described for manufacturing a roller for use in paper machines. Since the process runs linearly, the provision of a drawing was foregone. In a first step, a roll core is provided. This may consist, for example, of metal or plastic, and may be solid or hollow and may include a roll cover layer, for example a “base layer”. Moreover, at least one optical waveguide with a plurality of fiber Bragg gratings is provided, wherein sections of the at least one optical waveguide, each of which contains a fiber Bragg grating, alternate in the longitudinal direction with sections of the at least one optical waveguide which are free of a fiber Bragg grating.

Subsequently the roll core or the roll cover layer are marked, identifying regions in which a pressure measurement is to be made. This marking can be applied, for example by color or introduced in the form of a groove into the roll core or roll cover, which allows accommodation of the at least one optical waveguide. The step of applying a mark is only optional.

Then, segments of the at least one optical waveguide are attached, the segments each including a fiber Bragg grating, so that the segments together with a circumferential direction of the roller form an angle of less than 80°, for example less than 60° or less than 45°. The attachment can for example be detachable using an adhesive tape, making corrections more easily possible.

Subsequently, the remaining segments of the at least one optical waveguide, which are free of fiber Bragg gratings, are permanently attached, for example with epoxy resin to the roll core, or using a suitable glue to the roll cover layer. These segments which are free of fiber Bragg gratings can hereby form discretionary loops between the segments of the optical waveguide, which respectively are equipped with one fiber Bragg grating.

Subsequently, the detachable attachment of the segments of the at least one optical waveguide, each of which contains a fiber Bragg grating, is removed and these segments are permanently attached to the roll core, for example with epoxy resin or using a suitable adhesive on the roll cover layer before at least one further roll cover layer is applied.

Instead of the above, detachable connection of the segments of the at least one optical waveguide, each of which includes a fiber Bragg grating, may also be permanently connected with the roll or the roll cover layer. The step of removing the releasable compound can then be omitted.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A roll for use in a paper machine, the roll comprising:
a roll core;
a roll cover surrounding said roll core; and
at least one optical waveguide having a plurality of fiber Bragg-gratings, said at least one optical waveguide being arranged between said roll core and said roll cover or embedded in said roll cover, and a plurality of segments of said at least one optical waveguide including one of said plurality of fiber Bragg-gratings alternating in a longitudinal direction of said optical waveguide with a plurality of segments of said at least one optical waveguide including none of said fiber-Bragg-gratings, said segments of said at least one optical waveguide including said one fiber Bragg-grating enclosing an angle with a circumferential direction to the roll of less than approximately 80°.

2. The roll according to claim 1, wherein said segments of said at least one optical waveguide including said one fiber Bragg-grating enclosing said angle with said circumferential direction to the roll of less than 60°.

3. The roll according to claim 2, wherein said segments of said at least one optical waveguide including said one fiber Bragg-grating enclosing said angle with said circumferential direction to the roll of less than 45°.

4. A roll for use in a paper machine, the roll comprising:
a roll core providing a rotational axis of the roll;
a roll cover surrounding said roll core; and
at least one optical waveguide having a longitudinal extension and a plurality of fiber Bragg-gratings, said at least one optical waveguide being arranged between said roll core and said roll cover or embedded in said roll cover, said at least one optical waveguide progressing along said longitudinal extension on a cylinder surface concentric to said rotational axis of the roll, a plurality of segments of said at least one optical waveguide including one of said fiber Bragg-gratings alternating in said longitudinal direction of said optical waveguide with a plurality of segments of said at least one optical waveguide which are free of said fiber Bragg-gratings, at least some of said fiber Bragg-grating free segments progress curved at least in a plurality of sections of said cylinder surface.

5. A roll for use in a paper machine, the roll comprising:
a roll core;
a roll cover surrounding said roll core; and
at least one optical waveguide having a plurality of fiber Bragg-gratings, said at least one optical waveguide being arranged between said roll core and said roll cover or embedded in said roll cover, wherein a plurality of segments of said at least one optical waveguide including one of said fiber Bragg-gratings alternate in a longitudinal direction of said at least one optical waveguide with a plurality of segments of said at least one optical waveguide which are free of said fiber Bragg-gratings, and said at least one optical waveguide has a longitudinal extension along which said at least one optical waveguide progresses curved at least in sections, a radius of curvature of said curved progression being approximately 2 centimeters (cm) or greater.

6. The roll according to claim 5, wherein said radius of curvature of said curved progression is 3 cm or greater.

7. The roll according to claim 6, wherein said radius of curvature of said curved progression is 5 cm or greater.

8. The roll according to claim 5, wherein said segments having said one fiber Bragg-grating enclose an angle with a circumferential direction to the roll of less than approximately 80°.

9. The roll according to claim 8, wherein said segments having said one fiber Bragg-grating enclose said angle with said circumferential direction to the roll of less than 60°.

10. The roll according to claim 9, wherein said segments having said fiber Bragg-grating enclose said angle with said circumferential direction to the roll of less than 45°.

11. The roll according to claim 5, wherein said fiber Bragg-grating free segments of said at least one optical waveguide are curved in one direction of curvature.

12. The roll according to claim 5, wherein successive said fiber Bragg-grating free segments of said at least one optical waveguide, between which is arranged one of said segements including said one fiber Bragg-grating, are curved in different directions of curvature relative to each other.

13. The roll according to claim 12, wherein different said fiber Bragg-grating free segments of said at least one opitcal wave guide have a length which varies by a maximum of approximately 30%.

14. The roll according to claim 13, wherein said length of different said fiber Bragg-grating free segments of said at least one optical wave guide varies by a maximum of 10%.

15. The roll according to claim 12, wherein said length of different said fiber Bragg-grating free segments of said at least one optical waveguide is the same.

16. The roll according to claim 14, further comprising a casing surrounding said roll core, said casing in a region of said segments including said one fiber Bragg-grating is in contact directly with said roll core and said roll cover or directly with said roll cover.

17. The roll according to claim 16, wherein said segements of said optical wave guide including said one fiber Bragg-grating are arranged adjacent to each other in an axial direction of the roll.

18. The roll according to claim 17, wherein said segements including said one fiber Bragg-grating of said optical waveguide are arranged in a region extending over an entire roll length in said axial direction of the roll, said extension in said circumferential direction being less than approximately 15 centimeters (cm).

19. The roll according to claim 18, wherein said extension in said circumferential direction is less than 5 cm.

20. The roll according to claim 19, wherein said extension in said circumferential direction is less than 1 cm.

21. The roll according to claim 20, wherein said segments including said one fiber Bragg-grating are spaced apart at a constant distance in said axial direction of the roll.

22. The roll according to claim 21, said segements of one of said at least one optical waveguides including said one fiber Bragg-grating are arranged in said axial direction of the roll in a first region at a first distance from each other and in at least one second region at a second distance from each other, said second distance being at least 30% greater than said first distance.

23. The roll according to claim 22, wherein said second distance is at least 60% greater than said first distance.

24. The roll according to claim 23, wherein said second distance is at least 90% greater than said first distance.

25. The roll according to claim 24, wherein said at least one optical waveguide is more than one optical wave guide and adjacent said segements of different said optical waveguides including said one fiber Bragg-grating are arranged in a region extending in said circumferential direction of an entire circumference of said roll, said region in said axial direction of the roll being less than approximately 10 cm.

26. The roll according to claim 25, wherein said region in said axial direction of the roll being less than 5 cm.

27. The roll according to claim 26, wherein said region in said axial direction of the roll being less than 1 cm.

28. The roll according to claim 26, wherein said adjacent segments of said different optical waveguides including saind one fiber Bragg-grating are arranged in said circumferential direction of the roll offset relative to each other by 45° or more.

29. The roll according to claim 28, wherein said offset is 90° or more.

30. The roll according to claim 29, wherein said segements of a same said optical waveguide including said one fiber Bragg-grating are arranged along a helical curve along a surface of the roll, a deviation from said helical curve in said axial direction of the roll and a circumferential direction of the roll is less than approximately 15 cm.

31. The roll according to claim 30, wherein said deviation from said helical curve in said axial direction and said circumferential direction of the roll is less than 5 cm.

32. The roll according to claim 31, wherein said deviation from said helical curve in said axial direction and said circumferential direction of the roll is less than 1 cm.

33. The roll according to claim 32, wherein said at least one optical waveguide has a pair of ends, at least one of said ends being directed out of said roll cover.

34. The roll according to claim 33, wherein both of said pair of ends of said at least one optical waveguide are directed out of said roll cover.
